(19) United States
(12) Patent Application Publication
(10) Pub. No.: US 2002/0066219 A1
(43) Pub. Date: Jun. 6, 2002

(54) Method of using a stethoscope shield or diaphragm to display product promotional information

(76) Inventors: Richard C. Weidman, Great Falls, VA (US); W. Jeffrey Weidman, Reston, VA (US)

Correspondence Address: RICHARD C. WEIDMAN, 9505 NEUSE WAY, GREAT FALLS, VA, 22066, US

(21) Appl. No.: 10/010,857

(22) Filed: Dec. 5, 2001

Related U.S. Application Data
(60) Provisional application No. 60/251,233, filed on Dec. 6, 2000.

(51) Int. Cl. G09F 1/00

(52) U.S. Cl. 40/913

(57) ABSTRACT

A method of using a stethoscope diaphragm or a stethoscope shield to display product promotional and other information, other than information identifying said stethoscope diaphragm or said stethoscope shield. A method of using a stethoscope shield to transfer images displayed thereon to human skin upon applying said shield to said skin. A method of using the surface of any medical device to display product promotional and other information, other than information identifying said medical device.

### TECHNICAL FIELD OF THE INVENTION

The present invention relates to the method of using the surface of a stethoscope diaphragm or stethoscope shield for the purpose of displaying product promotional and other information.

### BACKGROUND OF THE INVENTION

Of the $13.8 billion spent by pharmaceutical companies last year to promote their products, $12.0 billion were spent in promotions directed at physicians and other health care providers with prescribing privileges (approximately one million prescribers). These promotions have taken many forms, and have included the distribution of free samples and free objects (such as pens and notepads) on which are imprinted the logos of drug companies and their products, along with product information.

The stethoscope is perhaps the most widely used and therapeutically symbolic of all medical instruments, and is present in all patient care areas and used by all physicians and other prescribing health care providers. Arguably, the several square centimeter surface of the diaphragm of the stethoscope is the most visible and esteemed area in the entire field of medicine. However, in spite of the fact that the flat surface of the diaphragm of the stethoscope is ideally suited for the promotional display of medical product and other information directed toward both the health provider and the patient, this surface has never before been used for this purpose. To date the only information displayed on the surface of stethoscope diaphragms and stethoscope shields has been for the purpose of product identification (e.g., identifying stethoscopes as being Littmann stethoscopes manufactured by the 3M Corporation, or identifying stethoscope shields as being of the Microguard brand).

There has also not been to date any description of the use of a stethoscope diaphragm or shield in a manner that would allay the fear and mistrust that children often experience when being examined by a health practitioner using a stethoscope.

### SUMMARY AND ADVANTAGES OF THE INVENTION

The present invention includes the method of using the surface of a stethoscope diaphragm or a stethoscope shield to display pharmaceutical product promotional information, including brand names, logos, and prescribing information. Drug promotional information would be particularly effective and appropriate if displayed on the surface of disposable stethoscope shields, such as those disclosed in U.S. Pat. No. 6,009,971 (“Self-Adherent Disposable Stethoscope Shield System”) previously granted to the present inventors. The reasons for this include:

1) There is an aura of therapeutic effectiveness associated with a product which has its name displayed on the medical instrument most closely associated with the healing powers of the physician, and which is literally present at the point of physician-patient contact (i.e., the surface of the stethoscope at the point at which it contacts the patient).

2) With each new examination of a patient, the prescribing physician comes into physical and visual contact with a stethoscope shield displaying prominently drug promotion information. This information would also be readily visible to the prescriber at the moment when a prescription is being written or medications are being ordered if, as is often the case, the physician is at the time actually wearing the stethoscope.

3) Disposable stethoscope shields could be used to promote any number of products in succession since a new shield with a new display is used with each successive patient examination. Particularly in the case of the shield system referenced above (U.S. Pat. No. 6,009,971) which discloses a stack of shields mounted on a stethoscope diaphragm (see FIG. 1 +L), each successive shield in the stack could bear a separate logo or drug promotion such that numerous products could be displayed successively as each shield is used and then peeled off and discarded.

4) Many of the negative connotations associated with drug product promotions in the mind of the public (e.g., that they cause an increase in the cost of drugs to consumers, unduly influence physicians in their choice of drugs, and promote the use of drugs which are not always in the best interest of patients) would be minimized or negated if the object used for promoting the drugs were itself of therapeutic benefit to patients, and if this object were only available through the sponsorship of drug manufacturers. Sponsorship by drug manufacturers of stethoscope shield systems would be expected to reduce the incidence of hospital-acquired and other infections, which would be of enormous public health benefit in addition to actually reducing the economic cost of these infections to society.

The information displayed on the stethoscope shield or diaphragm could also include health promotional information directed at the patient or the examiner—such as emphasizing the importance of hand washing between patient examinations—or a combination of product and health promotional/educational information, such that the patient or physician would positively associate the drug product or its manufacturer with the other information displayed that is clearly intended to benefit the health of the patient.

### ALTERNATIVE EMBODIMENT OF THE INVENTION

A specific embodiment of the present invention that is particularly relevant to pediatric patients is the display of images on a stethoscope shield that are transferable to the skin of the patient upon pressing the shield mounted on the stethoscope diaphragm against the skin, such as when performing a stethoscopic examination. In this way an image (such as that of a cartoon character) could be transferred from a stethoscope shield to the skin of a child, overcoming the natural reluctance of children to being examined by making the examination a form of playful activity that is easily understood by the child.

Although this patent application has described in detail specific applications involving stethoscope shields and diaphragms, it is not intended to be limited to these applications. More broadly, the invention should be considered to include the method of displaying any information on the surface of any medical device, exclusive of information identifying the device itself. This information includes pharmaceutical product and health promotional information.

We claim:

1) The method of using the surface of a diaphragm of a stethoscope to display information other than information that identifies said stethoscope, comprising the steps of:
providing a stethoscope diaphragm;
displaying said information on said diaphragm; and
showing said diaphragm displaying said information to other individuals.

2) The method of claim 1, wherein said displayed information comprises pharmaceutical product promotional information.

3) The method of claim 1 wherein said displayed information comprises health promotional information.

4) The method of using the surface of a stethoscope shield to display information other than information identifying said stethoscope shield, comprising the steps of:
providing a stethoscope shield;
displaying said information on the surface of said stethoscope shield; and
showing said surface displaying said information to other individuals.

5) The method of claim 4 wherein said displayed information comprises pharmaceutical product promotional information.

6) The method of claim 4 wherein said displayed information comprises health promotional information.

7) The method of claim 4 wherein said displayed information is transferable to human skin upon pressing said surface of said stethoscope shield to said skin.

8) The method of using the surface of any medical device to display information other than information identifying said device, comprising the steps of:
providing a medical device;
displaying said information on the surface of said device; and
showing said surface displaying said information to other individuals.

9) The method of claim 8 wherein said displayed information comprises pharmaceutical product promotional information.

10) The method of claim 8 wherein said displayed information comprises health promotional information.
